(19) United States
(12) Patent Application Publication
(10) Pub. No.: US 2018/0268697 A1
(43) Pub. Date: Sep. 20, 2018

(54) PORTABLE WIRELESS AUTOMOTIVE ANTI-COLLISION SYSTEM AND DATA PROCESSING METHOD

(71) Applicant: Tao LIN, Toronto, Ontario (CA)

(72) Inventors: Tao LIN, Toronto (CA); Bingying LIN, Guilin (CN)

(21) Appl. No.: 15/538,688

(22) PCT Filed: Aug. 9, 2016
(86) PCT No.: PCT/CN2016/094092

§ 371 Date: Jun. 22, 2017

(30) Foreign Application Priority Data
Dec. 28, 2015 (CN) 201510997157.0
Dec. 28, 2015 (CN) 201521104735.5

(51) Int. Cl. G08G 1/16; G01S 13/93; B60W 50/14

(52) U.S. Cl. CPC G08G 1/162; G01S 13/931; G08G 1/166; B60W 2420/52; B60W 2050/143; B60W 2420/42; B60W 50/14

(57) ABSTRACT

A portable wireless automotive anti-collision system includes wireless radar component, wireless camera component, solar battery component, signal switch, central controller, memory, voice alarm, and display screen. Wireless radar component and wireless camera component are wirelessly connected to central controller through signal switch. A driver issues command through display screen, and central controller invokes wireless radar component and wireless camera component for monitoring and photographing, and performs video picture display and voice alarm through display screen and voice alarm. Wireless radar component and wireless camera component may be are disposed on vehicle body by connection using magnetic force. Multi-point detection may be adopted, so that probability of collision of vehicle with pedestrians or obstacles may be reduced.

TECHNICAL FIELD

The present invention mainly relates to the field of automotive radar monitoring technologies, and in particular, to a portable wireless automotive anti-collision system and a data processing method.

### BACKGROUND

The working process of currently used automotive reverse image and radar systems is roughly as follows: first, a reversing camera and a radar are activated by a shift lever, vehicle rear video signals are transmitted to a display screen through a pre-installed wired circuit, and then the driver can observe the traffic condition at the rear of the vehicle, the radar sends an electrical signal upon detecting an obstacle, the electrical signal is transmitted to a sound system through a pre-installed wired circuit, and a warning sound is generated to warn the driver.

The aforementioned technology solves the problem that accidents are caused due to the fact that the driver cannot observe the rear of the vehicle when backing the vehicle, but has the following defects: (1) wired installation is required; (2) detachment and transfer are disabled; and (3) for large vehicles, blind areas exist at the sides of the vehicle when the vehicle makes a turn due to an excessively large turning radius, easily causing accidents.

### SUMMARY

The technical problem to be solved by the present invention is to provide a portable wireless automotive anti-collision system and a data processing method, where a wireless radar component and a wireless camera component are disposed on a vehicle body by connection using magnetic force, and detection devices are wirelessly connected to each other, so they can be quickly detached and are convenient to carry about, and a central controller turns on, through a wireless radar, a corresponding wireless camera to detect an obstacle, so that the present anti-collision system is quick in response, thereby improving obstacle detection accuracy of the present system.

The technical solution of the present invention for solving the aforementioned technical problem is as follows: a portable wireless automotive anti-collision system, including a display screen, a central controller, a wireless radar component, a wireless camera component, a voice alarm, and a signal switch that are fixed on a vehicle body, where the wireless radar component includes multiple wireless radars equipped with wireless transceivers, the wireless camera component includes multiple wireless cameras equipped with wireless transceivers, and each of the wireless radars and the wireless cameras is wirelessly connected, through the signal switch, to the central controller for registration;

the display screen is configured to receive operation commands and configured to perform video picture display and alarm information display;

the central controller is configured to encode each of the registered wireless radars and wireless cameras and match each of them with a corresponding monitoring area; further configured to, upon receiving a Monitor operation command, activate the wireless radar component, upon receiving a warning command of a wireless radar, send alarm information to the display screen and meanwhile activate a corresponding wireless camera; and configured to, upon receiving photographing data of a certain wireless camera, send the photographing data and matching monitoring area information to the display screen for display, and send a traffic condition alarm signal and the monitoring area information to the voice alarm;

the multiple wireless radars of the wireless radar component are all detachably distributed on an external surface of the vehicle body by magnetic force and enter a real-time detection state after being activated, and if a certain wireless radar detects that an obstacle enters into a preset distance range, the wireless radar sends, through the signal switch, alarm information to the central controller for processing;

the multiple wireless cameras of the wireless camera component are all detachably distributed on the external surface of the vehicle body by magnetic force, and after a certain wireless camera is activated, the wireless camera performs photographing and sends photographing data to the central controller through the signal switch;

the voice alarm is configured to perform broadcasting according to an alarm signal sent from the central controller and, upon receiving the traffic condition alarm signal, convert the monitoring area information into voice for broadcasting; and

the signal switch is configured to perform wireless signal connection between the wireless radar component, the wireless camera component, and the central controller and perform data exchange.

The wireless radar component and the wireless camera component both adopt waterproof packaging on the outside, so that the service life of the wireless radar component and the service life of the wireless camera component are prolonged.

The beneficial effects of the present invention are: a wireless radar component and a wireless camera component are disposed on a vehicle body by connection using magnetic force, and detection devices are wirelessly connected to each other, so they can be quickly detached and are convenient to carry about, and the present anti-collision system is especially suitable for installation on large vehicles with trailers, drivers can set and install the system according to different vehicles and their demands, the numbers and positions of wireless radars and wireless cameras can be arbitrarily selected, and multi-point detection can be adopted, so that the probability of collision of the vehicle with pedestrians or obstacles can be reduced to the largest extent; a central controller turns on, through a wireless radar, a corresponding wireless camera to detect an obstacle, so that the present anti-collision system is quick in response, thereby improving obstacle detection accuracy of the present system.

On the basis of the aforementioned technical solution, the present invention may further have the following improvements.

Further, the central controller is further configured to invoke, according to an Invoke operation command received by the display screen, a certain wireless radar for monitoring, activate, through a warning command of the wireless radar, a wireless camera in the monitoring area for photographing, and invoke the display screen to display photographing data and monitoring area information of the wireless camera and invoke the voice alarm to send a voice alarm.

The beneficial effect achieved by adopting the further solution is: when driving, a driver can invoke, according to needs, a wireless radar in a certain area for monitoring, which is convenient and practical.

Further, the central controller is further configured to invoke, according to a Photograph operation command received by the display screen, a certain wireless camera for photographing, and invoke the display screen to display photographing data and monitoring area information of the wireless camera.

The beneficial effect achieved by adopting the further solution is: the driver can also invoke wireless camera components located at different places to observe the whole environment of the vehicle, so that the driver is aware of all the surrounding conditions better. Further, the central controller is further configured to detect, through the signal switch in real time, whether the central controller is connected to the wireless radar component and the wireless camera component, and if the central controller is not connected to the wireless radar component and the wireless camera component, display Not Connected information through the display screen and broadcast Not Connected voice information through the voice alarm.

The beneficial effect achieved by adopting the further solution is: normal working of various external detection parts can be ensured, and the driver can further be prevented from forgetting to take away the system when replacing the vehicle.

Further, the portable wireless automotive anti-collision system further includes a memory configured to record various signal data, photographing data, and alarm data, receive a Clear operation command through the display screen, and clear data according to the Clear command.

The beneficial effect achieved by adopting the further solution is: the memory records data such as monitoring and alarm of driving to facilitate query, and data can also be cleared for using the memory repeatedly.

Further, the multiple wireless radars and the multiple wireless cameras are all provided with magnet devices and are detachably fixed on the external surface of the vehicle body by magnets.

The beneficial effect achieved by adopting the further solution is: the magnet devices can be directly adsorbed onto the vehicle body to facilitate arrangement and detachment without causing damage to the vehicle body.

Further, the portable wireless automotive anti-collision system further includes a solar charging device, where the solar charging device includes a solar panel and a solar battery part connected to the solar panel by a wire, the solar panel and the solar battery part are both disposed on the external surface of the vehicle body, the solar battery part is connected, by wires, to the wireless camera component and the wireless radar component for power supply, and the solar battery part is further provided with an external power interface; the portable wireless automotive anti-collision system further includes a rechargeable battery part disposed on the interior of the vehicle body, where the rechargeable battery part is separately connected by a wire, to the display screen, the central controller, the voice alarm, and the signal switch and provides power to them. The external power interface is a home power interface and a vehicle-mounted power charging interface.

The beneficial effect achieved by adopting the further solution is: the solar charging device not only can supply power to the wireless camera component and the wireless radar component but also is environmental-friendly; when the solar panel is not charged while traveling at night, the solar battery part can be charged by a home power supply or vehicle-mounted power supply to prevent the system from shutting down.

Further, when an electric quantity of the wireless camera component or the wireless radar component is equal to or lower than a preset electric quantity value, an electric quantity warning command is sent to the central controller through the signal switch, and the central controller sends Low Electric Quantity alarm information to the display screen for display and sends an electric quantity alarm signal to the voice alarm for voice broadcasting.

The beneficial effect achieved by adopting the further solution is: the system can be prevented from shutting down due to an excessively low electric quantity.

Further, the solar panel and the solar battery part are both provided with magnet devices, the solar panel is detachably fixed on the external surface of the vehicle body by a magnet, and the solar battery part is detachably fixed on the exterior of the vehicle body by a magnet.

The beneficial effect achieved by adopting the further solution is: the magnet devices can be directly adsorbed onto the vehicle body to facilitate arrangement and detachment without causing damage to the vehicle body.

Specifically, the central controller may include a numbering unit, where the numbering unit allocates an IP address to each of the registered wireless radars and wireless cameras and matches the wireless radar and the wireless camera of each IP address with a corresponding monitoring area outside the vehicle body, so that each wireless radar and each wireless camera perform monitoring and photographing on one corresponding area, thereby having the advantages of quick monitoring, quick query, and quick positioning.

Another technical solution of the present invention for solving the aforementioned technical problem is as follows: a data processing method for portable wireless automotive anti-collision uses the described automotive anti-collision system and includes the following steps:

step S1: wireless radars and wireless cameras are connected, through a signal switch, to a central controller for registration;

step S2: the central controller encodes each of the registered wireless radars and wireless cameras and matches each of them with a corresponding monitoring area;

step S3: a display screen receives an operation command;

step S4: the central controller activates a wireless radar component according to a Monitor operation command;

step S5: the wireless radars of the wireless radar component enter a real-time detection state after being activated, and if a certain wireless radar detects that an obstacle enters into a preset distance range, the wireless radar sends alarm information to the central controller through the signal switch to activate a corresponding wireless camera;

step S6: after a certain wireless camera is activated, the wireless camera performs photographing and sends photographing data to the central controller through the signal switch;

step S7: upon receiving photographing data of a certain wireless camera, the central controller sends the photographing data and matching monitoring area information to the display screen, and sends a traffic condition alarm signal and the monitoring area information to a voice alarm;

step S8: the display screen displays the photographing data and the monitoring area information; and

step S9: the voice alarm converts, according to the traffic condition alarm signal, the monitoring area information into voice for broadcasting.

On the basis of the aforementioned technical solution, the present invention may further have the following improvements.

Further, the data processing method further includes a step where the central controller invokes, according to an Invoke command received by the display screen, a certain wireless radar for monitoring, activates, through a warning command of the wireless radar, a wireless camera in the monitoring area for photographing, and invokes the display screen to display photographing data and monitoring area information of the wireless camera and invokes the voice alarm to send a voice alarm.

Further, the data processing method further includes a step where the central controller invokes, according to a Photograph operation command received by the display screen, a certain wireless camera for photographing, and invokes the display screen to display photographing data and monitoring area information of the wireless camera.

Further, the data processing method further includes a step where the central controller detects, through the signal switch in real time, whether the central controller is connected to the wireless radar component and the wireless camera component, and if the central controller is not connected to the wireless radar component and the wireless camera component, displays Not Connected information through the display screen and broadcasts Not Connected voice information through the voice alarm.

Further, the data processing method further includes a step where, when an electric quantity of the wireless camera component or the wireless radar component is equal to or lower than a preset electric quantity value, an electric quantity warning command is sent to the central controller through the signal switch, and the central controller sends Low Electric Quantity alarm information to the display screen for display and sends an electric quantity alarm signal to the voice alarm for voice broadcasting.

Further, the data processing method further includes a step where a memory records various signal data, photographing data, and alarm data, and a step of clearing data upon receiving a Clear operation command.

In summary, disclosed is a portable wireless automotive anti-collision system and a data processing method. The system includes a wireless radar component, a wireless camera component, and a solar battery component that are fixed on an exterior of a vehicle body by magnetic force, and a signal switch, a central controller, a memory, a voice alarm, and a display screen that are fixed in a drive cabin. The wireless radar component and the wireless camera component are wirelessly connected to the central controller through the signal switch. A driver issues a command through the display screen, and the central controller invokes, according to the command, the wireless radar component and the wireless camera component for monitoring and photographing, and performs video picture display and voice alarm through the display screen and the voice alarm. The wireless radar component and the wireless camera component of the present invention are disposed on the vehicle body by connection using magnetic force, so they can be quickly detached and are convenient to carry about, and the present anti-collision system is especially suitable for installation on large vehicles with trailers, and multi-point detection can be adopted, so that the probability of collision of the vehicle with pedestrians or obstacles can be reduced to the largest extent. The present anti-collision system is quick in response, thereby improving obstacle detection accuracy of the present system.

### BRIEF DESCRIPTION OF THE DRAWINGS

FIG. 1 is a modular block diagram of an automotive anti-collision system in the present invention;

FIG. 2 is a modular block diagram of a wireless radar component in the present invention;

FIG. 3 is a modular block diagram of a wireless camera component in the present invention;

FIG. 4 is a flow diagram of a data processing method in the present invention;

FIG. 5 is a schematic diagram illustrating display of a display screen in the present invention; and

FIG. 6 is a schematic diagram illustrating installation of a system embodiment in the present invention.

In the drawings, the names of the parts indicated by the reference numerals are as follows:

1 drive cabin

2 first trailer

3 second trailer

4 wireless radar

5 wireless camera

6 display screen

### DETAILED DESCRIPTION OF THE EXEMPLARY EMBODIMENT(S)

The principle and features of the embodiments of the present invention are described below with reference to the accompanying drawings, and the examples given are merely used for explaining the embodiments of the present invention and are not intended to limit the scope of the present invention (as described in the CLAIMS).

Various parts of the embodiments of the present invention are disposed on a vehicle body by detachable connection using magnetic force, and detection devices are wirelessly connected to each other, so they can be quickly detached and are convenient to carry about, and the present anti-collision system is especially suitable for installation on large vehicles with trailers, drivers can set and install the system according to different vehicles and their demands, the numbers and positions of wireless radars and wireless cameras can be arbitrarily selected, and multi-point detection can be adopted, so that the probability of collision of the vehicle with pedestrians or obstacles can be reduced to the largest extent; a corresponding wireless camera is turned on directly through a wireless radar to detect an obstacle, so that the present anti-collision system is quick in response, thereby improving obstacle detection accuracy of the present system.

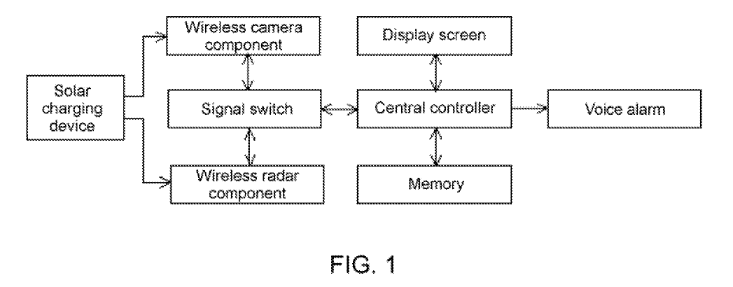

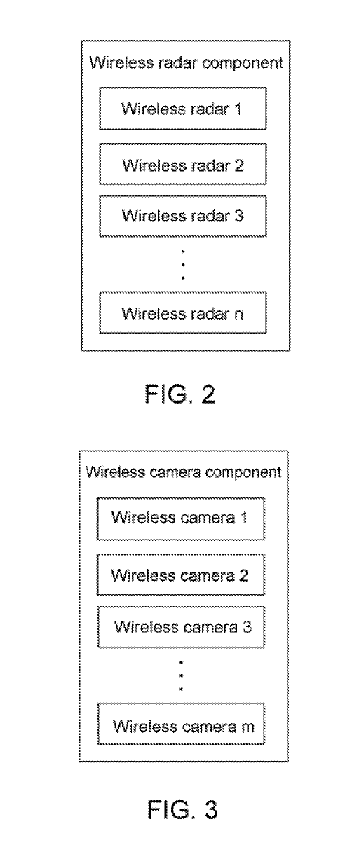

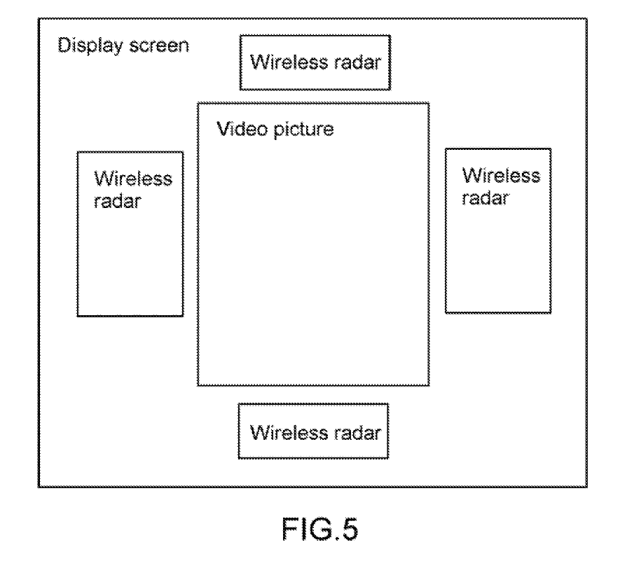

As shown in FIGS. 1, 2, 3, and 5, a portable wireless automotive anti-collision system of the embodiments of the present invention includes a display screen, a central controller, a wireless radar component, a wireless camera component, a voice alarm, and a signal switch that are fixed on a vehicle body, where the wireless radar component includes multiple wireless radars equipped with wireless transceivers, the wireless camera component includes multiple wireless cameras equipped with wireless transceivers, and each of the wireless radars and the wireless cameras is wirelessly connected, through the signal switch, to the central controller for registration; the central controller is separately connected to the display screen and the voice alarm by a data cable, and the signal switch is connected to the central controller by a data cable;

the display screen is connected to the central controller by a data cable and configured to receive operation commands and configured to perform video picture display and alarm information display; preferably, the display screen may be a touch display screen;

the central controller is configured to encode each of the registered wireless radars and wireless cameras and match each of them with a corresponding monitoring area; further configured to, upon receiving a Monitor operation command, activate the wireless radar component, upon receiving a warning command of a wireless radar, send alarm information to the display screen and meanwhile activate a corresponding wireless camera; and configured to, upon receiving photographing data of a certain wireless camera, send the photographing data and matching monitoring area information to the display screen for display, and send a traffic condition alarm signal and the monitoring area information to the voice alarm;

the multiple wireless radars of the wireless radar component are all detachably distributed on an external surface of the vehicle body by magnetic force and enter a real-time detection state after being activated, and if a certain wireless radar detects that an obstacle enters into a preset distance range, the wireless radar sends, through the signal switch, alarm information to the central controller for processing;

the multiple wireless cameras of the wireless camera component are all detachably distributed on the external surface of the vehicle body by magnetic force, and after a certain wireless camera is activated, the wireless camera performs photographing and sends photographing data to the central controller through the signal switch;

the voice alarm is connected to the central controller by a data cable and is configured to perform broadcasting according to an alarm signal sent from the central controller and, upon receiving the traffic condition alarm signal, convert the monitoring area information into voice for broadcasting; and

the signal switch is connected to the central controller by a data cable and configured to perform wireless signal connection between the wireless radar component, the wireless camera component, and the central controller and perform data exchange.

The central controller may further invoke, according to an Invoke operation command received by the display screen, a certain wireless radar for monitoring, activate, through a warning command of the wireless radar, a wireless camera in the monitoring area for photographing, and invoke the display screen to display photographing data and monitoring area information of the wireless camera and invoke the voice alarm to send a voice alarm.

The wireless signal may specifically adopt WiFi wireless signal or Bluetooth signal connection; after the driver starts the vehicle and the driver issues operation commands on the display screen, the wireless radar component is always in the On state and detects the surrounding area of the vehicle continuously, upon detecting that an obstacle enters into a preset range, a wireless radar sends an alarm command to the central controller through the signal switch to activate a corresponding camera, and meanwhile, information about the number and position of the wireless radar detecting the obstacle is displayed in an analog manner on the display screen, the camera also transmits, through the central controller, video data to the display screen for display, and the voice alarm converts, according to an alarm signal, monitoring area information into voice for broadcasting; when the driver issues an Off operation command, the central controller issues a stop instruction to cause the wireless cameras and the wireless radars to enter a sleep state.

The wireless radar component and the wireless camera component both adopt waterproof packaging on the outside.

When the driver needs to observe the front and rear traffic conditions, the driver may issue an Invoke command through the display screen, and the central controller invokes, according to the Invoke command received by the display screen, a certain wireless radar for monitoring, turns on, through the wireless radar, a wireless camera in the monitoring area for photographing, and invokes the display screen to display photographing data and monitoring area information of the wireless camera.

The central controller is further configured to invoke, according to a Photograph operation command received by the display screen, a certain wireless camera for photographing, and invoke the display screen to display photographing data and monitoring area information of the wireless camera.

The central controller is further configured to detect, through the signal switch in real time, whether the central controller is connected to the wireless radar component and the wireless camera component, and if the central controller is not connected to the wireless radar component and the wireless camera component, display Not Connected information through the display screen and broadcast Not Connected voice information through the voice alarm.

The portable wireless automotive anti-collision system further includes a memory that is connected to the central controller by a data cable and is configured to record various signal data, photographing data, and alarm data, receive a Clear operation command through the display screen, and clear data according to the Clear command. The memory is connected to the central controller by a data cable, when the display screen receives a Clear command from a user, the display screen sends the Clear command to the central controller, the central controller sends the Clear instruction to the memory, and the memory clears data.

The display screen, the central controller, the voice alarm, and the signal switch are provided with sucking disk devices and are detachably fixed in a drive cabin by sucking disks; the multiple wireless radars and the multiple wireless cameras are all provided with magnet devices and are detachably fixed on the external surface of the vehicle body by magnets.

Before placing the wireless cameras and the wireless radars, the driver may place them according to preset positions and sequences, or may install them according to his own needs, as long as the positions of the wireless cameras and the wireless radars are registered with the central processor so that the central processor determines their positions. When the vehicle runs normally, the display screen is in an off state, and when a wireless radar detects an obstacle, a wireless camera is activated by the central processor, the central processor invokes video data of the wireless camera for display through the display screen, and the voice alarm gives a voice alarm.

The portable wireless automotive anti-collision system further includes a solar charging device, where the solar charging device includes a solar panel and a solar battery part connected to the solar panel by a wire, the solar panel and the solar battery part are both disposed on the external surface of the vehicle body, the solar battery part is connected, by wires, to the wireless camera component and the wireless radar component for power supply, the solar battery part is further provided with an external power interface, and the external power interface is a home power interface and a vehicle-mounted power charging interface.

The portable wireless automotive anti-collision system further includes a rechargeable battery part disposed on the interior of the vehicle body, where the rechargeable battery part is separately connected, by a wire, to the display screen, the central controller, the voice alarm, and the signal switch and provides power to them. The central controller, the touch display screen, and the memory may further be supplied with power by a cigarette lighter socket in the drive cabin.

When an electric quantity of the wireless camera component or the wireless radar component is equal to or lower than a preset electric quantity value, an electric quantity warning command is sent to the central controller through the signal switch, and the central controller sends Low Electric Quantity alarm information to the display screen for display and sends an electric quantity alarm signal to the voice alarm for voice broadcasting.

The solar panel and the solar battery part are both provided with magnet devices, the solar panel is detachably fixed on the external surface of the vehicle body by a magnet, and the solar battery part is detachably fixed on the exterior of the vehicle body by a magnet.

Specifically, the central controller may include a numbering unit, where when a device leaves the factory, the numbering unit allocates an IP address to each of the registered wireless radars and wireless cameras and matches the wireless radar and the wireless camera of each IP address with a corresponding monitoring area outside the vehicle body, so that each wireless radar and each wireless camera perform monitoring and photographing on one corresponding area. For example, a wireless radar having an IP address of 001 is installed at the left-front position in the front of the vehicle, and the driver sets a device name 001 to correspond to the left-front position on the touch display screen, so that when the radar detects an obstacle, a wireless camera in the monitoring area is turned on through the signal switch for photographing, and the display screen displays a warning at the corresponding position.

Similarly, if a wireless camera is also installed in the front of the vehicle, when the radar at the left-front position in the front of the vehicle sends a warning signal, the central processor recognizes, according to the IP address of the radar, that the radar is installed at the left-front position in the front of the vehicle and activates the wireless camera in the front of the vehicle.

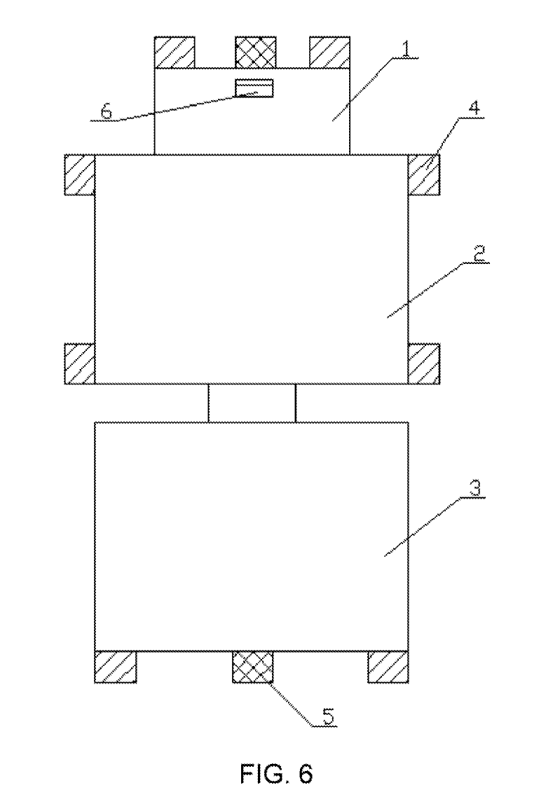

As shown in FIG. 6, a display screen 6 is installed in a drive cabin 1, a signal switch, a central controller, a memory, and a voice alarm (no shown) are also installed in the drive cabin 1, and multiple wireless radars 4 and multiple wireless cameras 5 (some of the wireless radars and the wireless cameras are not shown) are distributed on the front of the vehicle as well as on external surfaces of a first trailer 2 and a second trailer 3 of the vehicle body; the solar charging device (not shown) is fixed on the external surface of the vehicle body near the wireless radars and the wireless cameras.

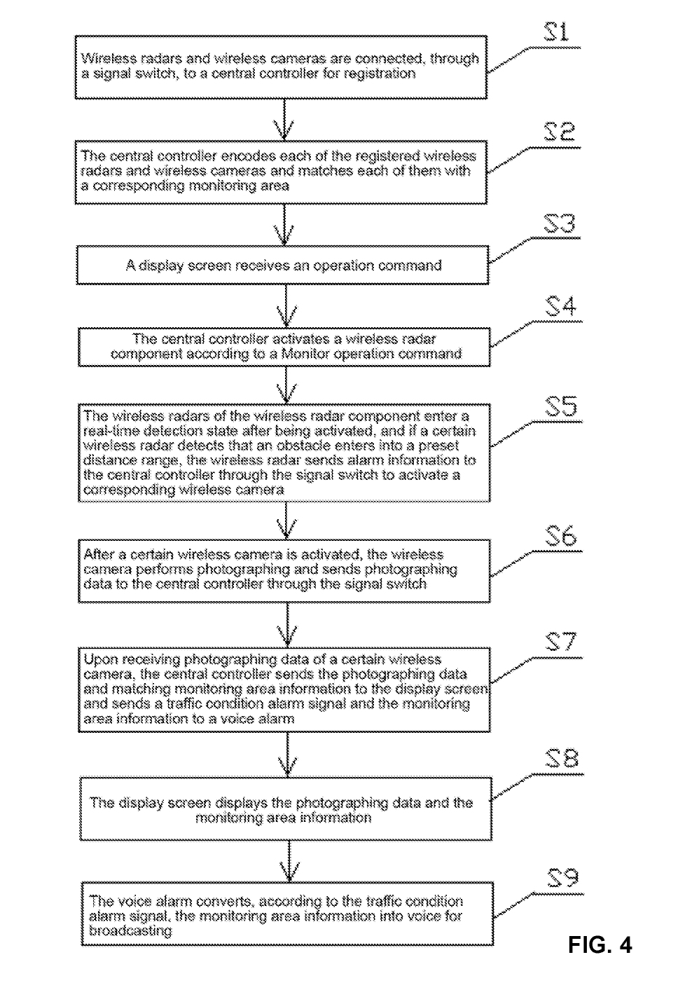

As shown in FIG. 4, a data processing method for portable wireless automotive anti-collision uses the described automotive anti-collision system and includes the following steps:

step S1: wireless radars and wireless cameras are connected, through a signal switch, to a central controller for registration;

step S2: the central controller encodes each of the registered wireless radars and wireless cameras and matches each of them with a corresponding monitoring area;

step S3: a display screen receives an operation command;

step S4: the central controller activates a wireless radar component according to a Monitor operation command;

step S5: the wireless radars of the wireless radar component enter a real-time detection state after being activated, and if a certain wireless radar detects that an obstacle enters into a preset distance range, the wireless radar sends alarm information to the central controller through the signal switch to activate a corresponding wireless camera;

step S6: after a certain wireless camera is activated, the wireless camera performs photographing and sends photographing data to the central controller through the signal switch;

step S7: upon receiving photographing data of a certain wireless camera, the central controller sends the photographing data and matching monitoring area information to the display screen, and sends a traffic condition alarm signal and the monitoring area information to a voice alarm;

step S8: the display screen displays the photographing data and the monitoring area information; and

step S9: the voice alarm converts, according to the traffic condition alarm signal, the monitoring area information into voice for broadcasting.

Specifically, the central controller allocates an IP address to each of the registered wireless radars and wireless cameras and matches the wireless radar and the wireless camera of each IP address with a corresponding monitoring area outside the vehicle body, so that each wireless radar and each wireless camera perform monitoring and photographing on one corresponding area.

The data processing method further includes a step where the central controller invokes, according to an Invoke command received by the display screen, a certain wireless radar for monitoring, activates, through a warning command of the wireless radar, a wireless camera in the monitoring area for photographing, and invokes the display screen to display photographing data and monitoring area information of the wireless camera and invokes the voice alarm to send a voice alarm.

The data processing method further includes a step where the central controller is further configured to invoke, according to a Photograph operation command received by the display screen, a certain wireless camera for photographing, and invoke the display screen to display photographing data and monitoring area information of the wireless camera.

The data processing method further includes a step where the central controller detects, through the signal switch in real time, whether the central controller is connected to the wireless radar component and the wireless camera component, and if the central controller is not connected to the wireless radar component and the wireless camera component, displays Not Connected information through the display screen and broadcasts Not Connected voice information through the voice alarm.

The data processing method further includes a step where, when an electric quantity of the wireless camera component or the wireless radar component is equal to or lower than a preset electric quantity value, an electric quantity warning command is sent to the central controller through the signal switch, and the central controller sends Low Electric Quantity alarm information to the display screen for display and sends an electric quantity alarm signal to the voice alarm for voice broadcasting.

The data processing method further includes a step where a memory records various signal data, photographing data, and alarm data, and a step of clearing data upon receiving a Clear operation command.

The driver can use the automotive anti-collision system oft the embodiments of the present invention to monitor the traffic condition around the whole vehicle, and can also invoke a wireless radar in a certain area for monitoring, which is convenient and practical and reduces the probability of collision of the vehicle with pedestrians or obstacles to the largest extent.

The above descriptions are merely preferred embodiments of the present invention and are not intended to limit the present invention (as described in the CLAIMS). Any modification, equivalent replacement, or improvement made without departing from the spirit and principle of the present invention (as claimed) should fall within the protection scope of the present invention (as claimed).

What is claimed is:

1. A portable wireless automotive anti-collision system, comprising:
a display screen;
a central controller;
a wireless radar component;
a wireless camera component;
a voice alarm; and
a signal switch that are fixed on a vehicle body;
wherein the wireless radar component comprises multiple wireless radars equipped with wireless transceivers;
the wireless camera component comprises multiple wireless cameras equipped with wireless transceivers;
each of the wireless radars and the wireless cameras is wirelessly connected, through the signal switch, to the central controller for registration;
the display screen is configured to receive operation commands and configured to perform video picture display and alarm information display;
the central controller is configured to encode each of the registered wireless radars and wireless cameras and match each of them with a corresponding monitoring area, and is further configured to, upon receiving a Monitor operation command, activate the wireless radar component, upon receiving a warning command of a wireless radar, send alarm information to the display screen and meanwhile activate a corresponding wireless camera, and is further configured to, upon receiving photographing data of a certain wireless camera, send the photographing data and matching monitoring area information to the display screen for display, and send a traffic condition alarm signal and the monitoring area information to the voice alarm;
the multiple wireless radars of the wireless radar component are all detachably distributed on an external surface of the vehicle body by magnetic force and enter a real-time detection state after being activated, and if a certain wireless radar detects that an obstacle enters into a preset distance range, the wireless radar sends, through the signal switch, alarm information to the central controller for processing;
the multiple wireless cameras of the wireless camera component are all detachably distributed on the external surface of the vehicle body by magnetic force, and after a certain wireless camera is activated, the wireless camera performs photographing and sends photographing data to the central controller through the signal switch;
the voice alarm is configured to perform broadcasting according to an alarm signal sent from the central controller and, upon receiving the traffic condition alarm signal, convert the monitoring area information into voice for broadcasting; and
the signal switch is configured to perform wireless signal connection between the wireless radar component, the wireless camera component, and the central controller and perform data exchange.

2. The portable wireless automotive anti-collision system according to claim 1, wherein:
the central controller is further configured to invoke, according to an Invoke operation command received by the display screen, a certain wireless radar for monitoring, activate, through a warning command of the wireless radar, a wireless camera in the monitoring area for photographing, and invoke the display screen to display photographing data and monitoring area information of the wireless camera and invoke the voice alarm to send a voice alarm.

3. The portable wireless automotive anti-collision system according to claim 1, wherein:
the central controller is further configured to invoke, according to a Photograph operation command received by the display screen, a certain wireless camera for photographing, and invoke the display screen to display photographing data and monitoring area information of the wireless camera.

4. The portable wireless automotive anti-collision system according to claim 1, wherein:
the central controller is further configured to detect, through the signal switch in real time, whether the central controller is connected to the wireless radar component and the wireless camera component, and if the central controller is not connected to the wireless radar component and the wireless camera component, display Not Connected information through the display screen and broadcast Not Connected voice information through the voice alarm.

5. The portable wireless automotive anti-collision system according to claim 1, further comprising:
a memory configured to record various signal data, photographing data, and alarm data, receive a Clear operation command through the display screen, and clear data according to the Clear command.

6. The portable wireless automotive anti-collision system according to claim 1, wherein:
the multiple wireless radars and the multiple wireless cameras are all provided with magnet devices and are detachably fixed on the external surface of the vehicle body by magnets.

7. The portable wireless automotive anti-collision system according to claim 1, further comprising:
a solar charging device;
wherein the solar charging device comprises a solar panel and a solar battery part connected to the solar panel by a wire, the solar panel and the solar battery part are both disposed on the external surface of the vehicle body, the solar battery part is connected, by wires, to the wireless camera component and the wireless radar component for power supply, and the solar battery part is further provided with an external power interface; and
the portable wireless automotive anti-collision system further comprises a rechargeable battery part disposed on the interior of the vehicle body, wherein the rechargeable battery part is separately connected, by a wire, to the display screen, the central controller, the voice alarm, and the signal switch and provides power to them.

8. The portable wireless automotive anti-collision system according to claim 7, wherein:
when an electric quantity of the wireless camera component or the wireless radar component is equal to or lower than a preset electric quantity value, an electric quantity warning command is sent to the central controller through the signal switch, and the central controller sends Low Electric Quantity alarm information to the display screen for display and sends an electric quantity alarm signal to the voice alarm for voice broadcasting.

9. The portable wireless automotive anti-collision system according to claim 7, wherein:
the solar panel and the solar battery part are both provided with magnet devices, the solar panel is detachably fixed on the external surface of the vehicle body by a magnet, and the solar battery part is detachably fixed on the exterior of the vehicle body by a magnet.

10. A data processing method for portable wireless automotive anti-collision, the method comprising the following steps:
step S1: wireless radars and wireless cameras are connected, through a signal switch, to a central controller for registration;
step S2: the central controller encodes each of the registered wireless radars and wireless cameras and matches each of them with a corresponding monitoring area;
step S3: a display screen receives an operation command;
step S4: the central controller activates a wireless radar component according to a Monitor operation command;
step S5: the wireless radars of the wireless radar component enter a real-time detection state after being activated, and if a certain wireless radar detects that an obstacle enters into a preset distance range, the wireless radar sends alarm information to the central controller through the signal switch to activate a corresponding wireless camera;
step S6: after a certain wireless camera is activated, the wireless camera performs photographing and sends photographing data to the central controller through the signal switch;
step S7: upon receiving photographing data of a certain wireless camera, the central controller sends the photographing data and matching monitoring area information to the display screen, and sends a traffic condition alarm signal and the monitoring area information to a voice alarm;
step S8: the display screen displays the photographing data and the monitoring area information; and
step S9: the voice alarm converts, according to the traffic condition alarm signal, the monitoring area information into voice for broadcasting.

11. The data processing method for portable wireless automotive anti-collision according to claim 10, further comprising:
a step where the central controller invokes, according to an Invoke command received by the display screen, a certain wireless radar for monitoring, activates, through a warning command of the wireless radar, a wireless camera in the monitoring area for photographing, and invokes the display screen to display photographing data and monitoring area information of the wireless camera and invokes the voice alarm to send a voice alarm.

12. The data processing method for portable wireless automotive anti-collision according to claim 10, further comprising:
a step where the central controller invokes, according to a Photograph operation command received by the display screen, a certain wireless camera for photographing, and invokes the display screen to display photographing data and monitoring area information of the wireless camera.

13. The data processing method for portable wireless automotive anti-collision according to claim 10, further comprising:
a step that the central controller detects, through the signal switch in real time, whether the central controller is connected to the wireless radar component and the wireless camera component, and if the central controller is not connected to the wireless radar component and the wireless camera component, displays Not Connected information through the display screen and broadcasts Not Connected voice information through the voice alarm.

14. The data processing method for portable wireless automotive anti-collision according to claim 10, further comprising:
a step where, when an electric quantity of the wireless camera component or the wireless radar component is equal to or lower than a preset electric quantity value, an electric quantity warning command is sent to the central controller through the signal switch, and the central controller sends Low Electric Quantity alarm information to the display screen for display and sends an electric quantity alarm signal to the voice alarm for voice broadcasting.

15. The data processing method for portable wireless automotive anti-collision according to claim 10, further comprising:
a step of recording various signal data, photographing data, and alarm data, and a step of clearing data upon receiving a Clear operation command.
